(19) United States
(12) Patent Application Publication
(10) Pub. No.: US 2006/0206680 A1
(43) Pub. Date: Sep. 14, 2006

(54) File control apparatus

(75) Inventors: Hideki Yamanaka, Kawasaki (JP); Shigeru Akiyama, Kawasaki (JP); Satoshi Hayashi, Kawasaki (JP); Takashi Okuno, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/237,841

(22) Filed: Sep. 29, 2005

(30) Foreign Application Priority Data
Mar. 11, 2005 (JP) 2005-068676

(51) Int. Cl. G06F 12/00

(52) U.S. Cl. 711/170; 711/114

(57) ABSTRACT

When receiving a request for a write, write data is added by identifier information for confirming the normality of the data and then written to a storage apparatus, with the identifier information being added to format information, of a writing track, which is recorded in a track format table. And when receiving a request for a read, the requester is notified of a data abnormality if identifier information of data read from a storage apparatus does not identify with that of format information, of the reading track, which is recorded in the track format table.

### BACKGROUND OF THE INVENTION

1. Field of the Invention

The present invention relates to a file control apparatus for controlling writing to, and reading from, a storage apparatus, a file containing a plurality of records in response to an access request from a requester.

2. Description of the Related Art

A disk array system such as RAID (Redundant Array of Inexpensive Disks) is equipped with a controller for performing read and write control for a file when receiving a request for a read and/or write from a host computer for a magnetic disk apparatus.

FIG. 1A exemplifies a comprisal of such a disk array system. The disk array system shown by FIG. 1A includes a host computer 11 and a disk array apparatus 12 which comprises a channel adaptor (CA) 21, a controller 22 and a plurality of disks 23-1 through 23-p, with each disk comprising one or more disk apparatuses.

The host computer 11 accesses the disks 23-1 through 23-p by way of the channel adaptor 21 and controller 22, in which the controller 22 stores write data received from the host computer 11 in a cache memory 24 temporarily, followed by reading it out thereof and writing it to a disk 23 as an object of access (“an access object disk 23” hereinafter); also stores read data read from the access object disk 23 in the cache memory 24 temporarily, followed by reading it out therefrom and transmitting it to the host computer 11.

If the disks 23-1 through 23-p store variable length records, a track format table (TFT) defining a record format per track for each disk is furnished in the cache memory 24 (e.g., refer to the patent document 1 below) The controller 22 retains data in the cache memory 24 in the same format as each disk.

[Patent document 1] Japanese registered patent No. 3260998

The above described conventional file control, however, has been faced with the following problem.

When the controller 22 writes data retained by the cache memory 24 to an access object disk 23, a missed write may occur where no data is actually written although the disk 23 has responded back with a message “write complete”. In such a case, when the host computer 11 requests to read the file containing the data, the host computer 11 ultimately receives pre-written stale data.

FIG. 1B shows a sequence of such a missed writing occurrence. First, the host computer 11 transmits a request for a write to the channel adaptor 21 (step 1301) which then requests a memory area in the cache memory 24 of the controller 22 (step 1302). Having received this request, the controller 22 provides the channel adaptor 21 with a memory area (step 1303) and the channel adaptor 21 reads the format information of a write object track from the TFT stored in the cache memory 24 (step 1304).

The channel adaptor then writes the data transmitted from the host computer 11 to the memory area of the cache memory 24 conforming to the format information (step 1305); and further writes the format information after the change in the TFT (step 1306) if a change of the track format information is necessary. Then the channel adaptor 21 transmits a response with a message “completed normally” back to the host computer 11 (step 1307) and releases the memory which has been provided by the controller 22 (step 1308).

Subsequently the controller 22 transmits a request for a write to the disk 23 (step 1309) and writes the data retained by the cache memory 24 to the disk 23 (step 1310), in which the disk 23 transmits a response back to the controller 22 of “completed normally”, even if a missed write occurs (step 1311).

FIG. 1C shows a sequence for a data read following a missed write occurrence. First, the host computer 11 transmits a request for a data read of data written to the disk 23 to the channel adaptor 21 (step 1401) which then requests a memory area in the cache memory 24 of the controller 22 (step 1402). Having received this request, the controller 22 temporarily transmits a response back to the channel adaptor 21 to interrupt processing (step 1403).

The controller 22 then transmits a request for a read to the disk 23 (step 1404) and writes the data transmitted from the disk 23 in the memory area of the cache memory 24 conforming to the format information defined by the TFT (step 1405). The disk 23 then transmits a response back to the controller 22 of “completed normally” (step 1406).

Having received the response, the controller 22 transmits a response back to the channel adaptor 21 of “restarting process” (step 1407) and provides the channel adaptor 21 with the memory area in which the data is written (step 1408). The channel adaptor 21 then reads the format information of the reading track from the TFT retained by the cache memory 24 (step 1409).

The channel adaptor 21 reads the data from the cache memory 24 conforming to the format information and transmits the data to the host computer 11 (step 1410) followed by transmitting a response back to the host computer 11 of “completed normally” (step 1411) and releasing the memory area provided by the controller 22 (step 1412).

In this event, the host computer 11 ultimately receives stale data stored in the reading track, with corrupt data, without ever recognizing the fact thereof since the host computer 11 has received a response of “completed normally”, thus continuing processing while regarding the transmitted corrupt data as normal and hence outputting an erroneous processing result.

### SUMMARY OF THE INVENTION

The challenge of the present invention is to prevent the execution of invalid processing at the time of a missed write occurrence when writing a file to a storage apparatus by using a TFT, by letting the requester of the read of the written data recognize the abnormality.

A file control apparatus according to the present invention, comprising a storage device, a cache device and a control device, controls writing to, and reading from, a storage apparatus, a file containing a plurality of records in response to an access request from a requester.

The storage device stores a track format table which records format information about each track of the storage apparatus. The cache device stores write data to be written to the storage apparatus and data read thereof.

The control device writes to the storage apparatus write data transmitted from the requester by adding identifier information thereto in order to confirm the normality of the write data, adds the identifier information to format information, of a writing track, which is recorded in the track format table when receiving a request for a write from the requester, and notifies the requester of a data abnormality if the identifier information of data read from the storage apparatus does not identify with the identifier information of the format information, of the reading track, which is recorded in the track format table when receiving a request for a read from the requester.

### BRIEF DESCRIPTION OF THE DRAWINGS

FIG. 1A is a comprisal of a disk array system;

FIG. 1B shows a missed write occurrence;

FIG. 1C shows corrupted data caused by a missed write;

FIG. 2A shows the principle of a file control apparatus according to the present invention;

FIG. 2B shows a comprisal of a disk array system with two controllers;

FIG. 3 shows a COF format;

FIG. 4 shows format information contained in a track format table;

FIG. 5 shows a first write sequence;

FIG. 6 shows a first read sequence;

FIG. 7 shows a second write sequence;

FIG. 8 shows a second read sequence;

FIG. 9 shows a third read sequence;

FIG. 10 shows a fourth read sequence; and

FIG. 11 shows a method for providing a program and data.

### DESCRIPTION OF THE PREFERRED EMBODIMENTS

The following is a detailed description of the preferred embodiment of the present invention while referring to the accompanying drawings.

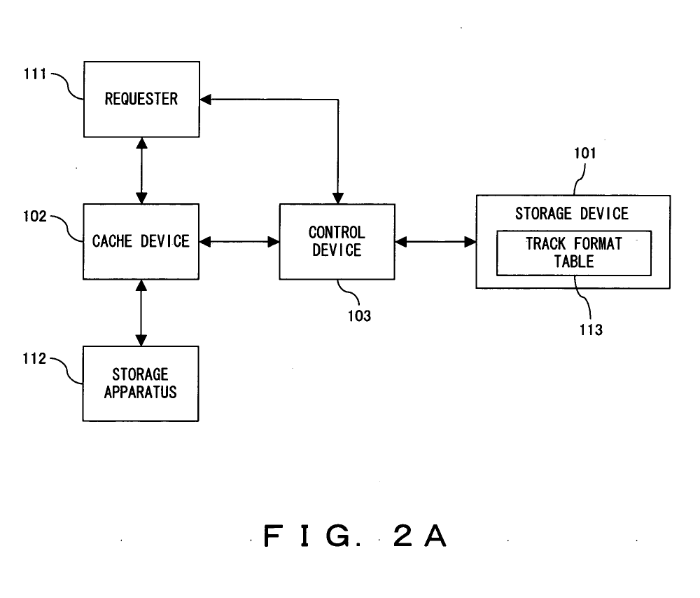

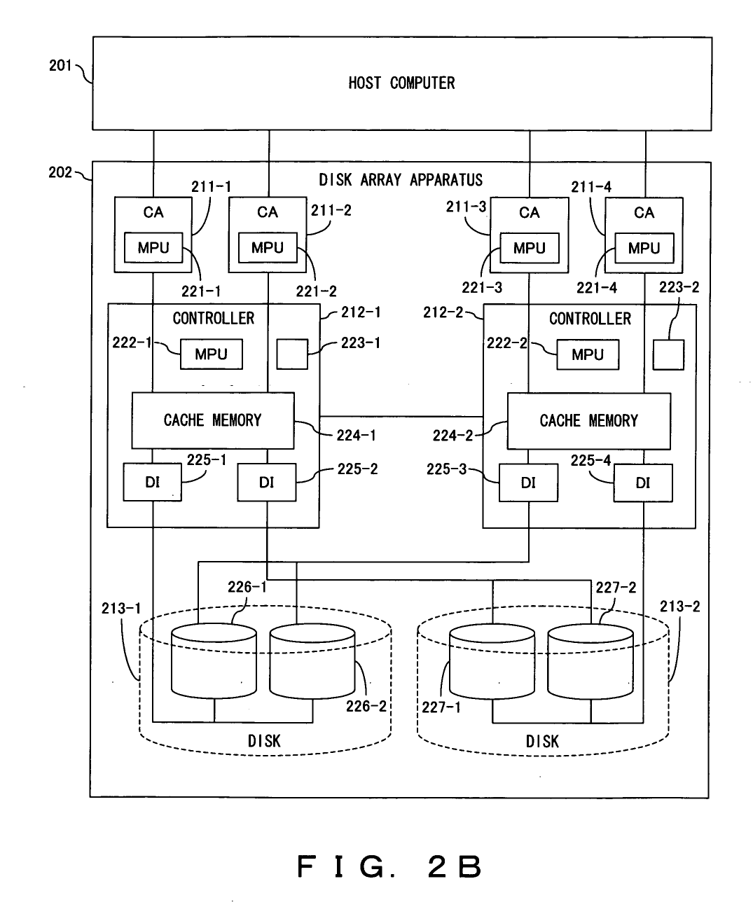

FIG. 2A shows the principle of a file control apparatus according to the present invention. The file control apparatus shown by FIG. 2A, comprising a storage device 101, a cache device 102 and a control device 103, controls writing to, and reading from, a storage apparatus 112, a file containing a plurality of records in response to an access request from a requester 111.

The storage device 101 stores a track format table 113 which records format information about each track of the storage apparatus 112. The cache device 102 stores write data to be written to the storage apparatus 112 and data read thereof.

The control device 103 writes a write data transmitted from the requester 111 by adding identifier information for confirming the normality of the write data in the storage apparatus 112, adds the identifier information to format information, about a writing track (i.e., a track to write data to), which is recorded in a track format table 113 when receiving a request for a write from the requester 111; and notifies the requester 111 of a data abnormality if the identifier information of read data from the storage apparatus 112 does not identify with the identifier information of the format information, of the reading track (i.e., track to read data from), which is recorded in the track format table 113 when receiving a read request from the requester 111.

The same identifier information is added to both write data and the format information of the writing track when writing the data, and the identifier information of read data and that of the format information of the reading track (i.e., a track to read data from) when reading the data. Then, the data readout is judged to be normal if both pieces of identifier information identify with each other, while the data readout is judged to be abnormal if they do not identify with each other. If normal, the data readout is transmitted to the requester 111, while if abnormal, then the requester 111 will be notified of the data being abnormal.

If a missed write occurs, resulting in the identifier information of the data readout and that of the format information of the reading track becoming non-identical, the requester 111 will be notified of the abnormality of the data, enabling the requester 111 to recognize the abnormality.

The storage device 101 and cache device 102 correspond to later described cache memories 224-i (i=1, 2) shown by FIG. 2B, for example, and the control device 103 corresponds to MPUs (micro processing unit) 221-i (i=1, 2, 3, 4) or MPUs 222-i (i=1, 2) both shown, by FIG. 2B for example.

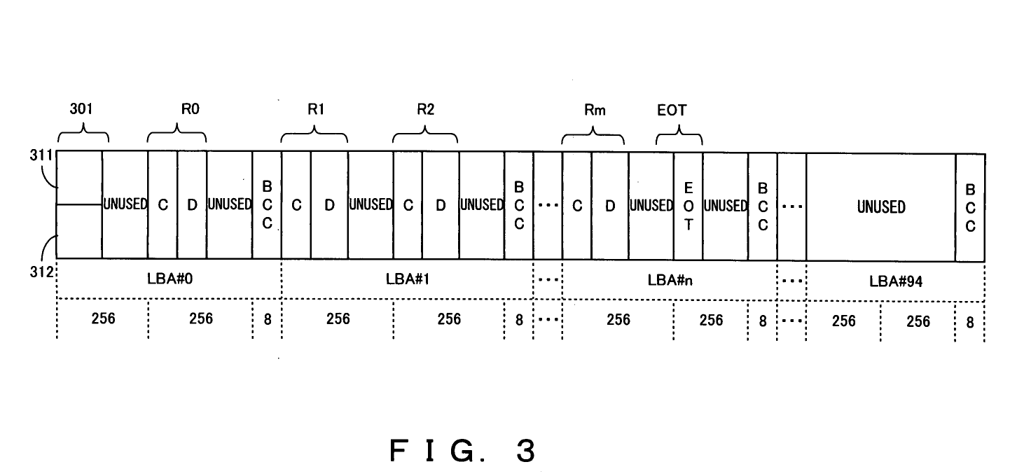

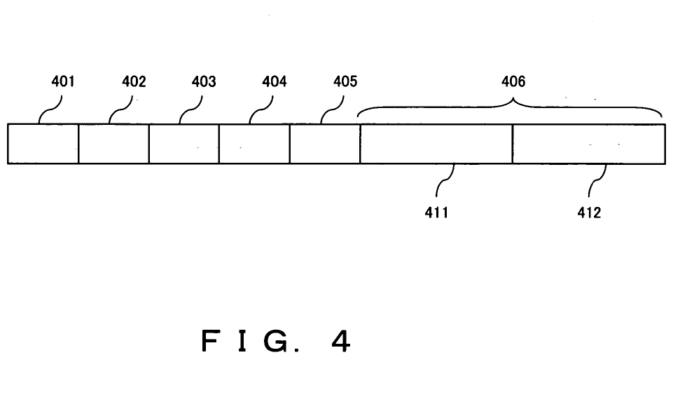

The requester 111 corresponds to a host computer 201 shownby FIG. 2B for example, and the storage apparatus 112 corresponds to disks 213-i (i=1, 2) shown by FIG. 2B for example. The identifier information added to data corresponds to a later described assurance code 301 shown by FIG. 3 for example, and the identifier information added to the format information corresponds to a later described assurance code 406 shown by FIG. 4 for example.

According to the present invention, if a missed write occurs when writing a file to a storage apparatus, the requester is enabled to recognize the abnormality when reading the written data, enabling the requester to carry out an appropriate recovery operation.

FIG. 2B exemplifies a comprisal of a disk array system according to the present embodiment. The disk array system shown by FIG. 2B comprises a host computer 201 and a disk array apparatus 202 which comprises channel adaptors (CA) 211-1 through 211-4, controllers 212-1 and 212-2, and disks 213-1 and 213-2.

There are only two disks shown herein, but there will commonly be p-number of disks being installed in a disk array apparatus 202. Each disk comprises one or more disk apparatuses, while the host computer 201 requests a data write or read by regarding each disk as one storage apparatus.

If the disk 213-1 corresponds to a RAID-1 disk and comprises magnetic disk apparatuses 226-1 and 226-2 for example, data mirroring will be carried out between these magnetic disk apparatuses, in which the same data will be written to both magnetic disk apparatuses 226-1 and 226-2 simultaneously.

Likewise, if the disk 213-2 corresponds to a RAID-1 disk and comprises magnetic disk apparatuses 227-1 and 227-2 for example, data mirroring will be carried out between these magnetic disk apparatuses.

The disk array apparatus 202 is dualized by comprising two controllers 212-1 and 212-2, with each controller being enabled to communicate with the host computer 201 by way of two channel adaptors 211.

The channel adaptors 211-i (i=1, 2, 3, 4) include MPUs (micro processing units) 221-i. The controller 212-1 includes an MPU 222-1, memory 223-1, a cache memory 224-1 and drive interfaces (DI) 225-1 and 225-2; while the controller 212-2 includes an MPU 222-2, memory 223-2, a cache memory 224-2 and drive interfaces (DI) 225-3 and 225-4.

Each of the MPUs 221-1, 221-2 and 222-1 carries out necessary processing by executing a program stored in the memory 223-1 for example. Each of the MPUs 221-3, 221-4 and 222-2 carries out necessary processing by executing a program stored in the memory 223-2 for example.

The host computer 201 transmits a request for a write and/or read to the controller 212 by way of either of the channel adaptors 211 and accesses the disk 213 byway of the controller 212. The following description is of the case of the controller 212-1 receiving an access request from the host computer 201 by way of the channel adaptor 211-1.

The controller 212-1 retains, in the cache memory 224-1, a TFT which records format information about each track of the disks 213-i (i=1, 2), adds a code for assuring data to both each track of the disk 213-i and the corresponding format information defined by the TFT, and thereby manages the relationship between the aforementioned entities. And the controller 212-1 compares the assurance code of the data with that of the TFT to confirm normality of the data readout when reading the data from the disks 213-i.

Each of the disk apparatuses equipped in the disks 213-i adopts a data format called COF (CKD on FBA) in order to store variable length data in a CKD (count key data) format by using an FBA (fixed block architecture).

FIG. 3 shows a data structure of the COF format used in a main frame computer. The shown example uses the standard format in which one track is made up of ninety five (95) logical blocks, i.e., LBA #0 through #94, and each logical block is made up of 512-bytes of working data and 8-bytes of block check code (BCC). The logical block corresponds to the unit of data storage in a magnetic disk apparatus.

The working data area is divided into two 256-byte areas, with the each area capable of storing one record. Each record is generally made up of a count part C, key part K and data part D.

The count part C stores a track address, a record number, and the lengths of the following key part K and data part D, et cetera; and the key part K stores key data subsequent to the count part C. In this example, however, the length of the key part K is set to zero (0), and therefore the key part K is not used. The track address is a physical address for a track within the disks 213-i, comprising a cylinder value and ahead value for example. The data part D stores data subsequent to the count part C or key part K.

The assurance code 301 for the LBA #0 is a code for assuring the normality of the data stored in the track, being made up of a 6-byte time stamp 311 and 2-bytes for the number of updates 312 for example. The time stamp 311 is information about the date and time of writing the data (e.g., yy/mm/dd/hh:nn:ss), and the number of updates 312 is a number which will be incremented at every data write.

R0 in LBA #0 is a record of the record number 0 (zero) which is operated by making the length of the key part 0 (zero) bytes and that of data part 8 bytes, and which is used for storing special data. R1 through Rm in the LBA #1 through #n, respectively, are variable length records of the record numbers 1 through m, and are for storing common data. The EOT in the LBA #n is a special data pattern for indicating the end of the track.

FIG. 4 shows format information contained by a TFT retained in the cache memory 224-1. The format information comprises a track address 401, the number of intra-track records 402, a starting record number 403, a control flag 404, a data record length 405 and an assurance code 406; and is furnished with each track.

The number of intra-track records 402 indicates the number of records being recorded in the applicable track, and the starting record number 403 indicates the number for the head record in the track. The control flag 404 can be a flag for indicating whether the track is valid or invalid, a flag for indicating whether the format is standard or not, a flag for indicating whether the format information is valid or invalid, et cetera. The record data length 405 indicates the length of the record area when applying the standard format, 256 bytes in the case of FIG. 3. And the assurance code 406 is made up of a 6-byte time stamp 411 and 2-bytes for the number of updates 412 as with the assurance code 301 shown by FIG. 3.

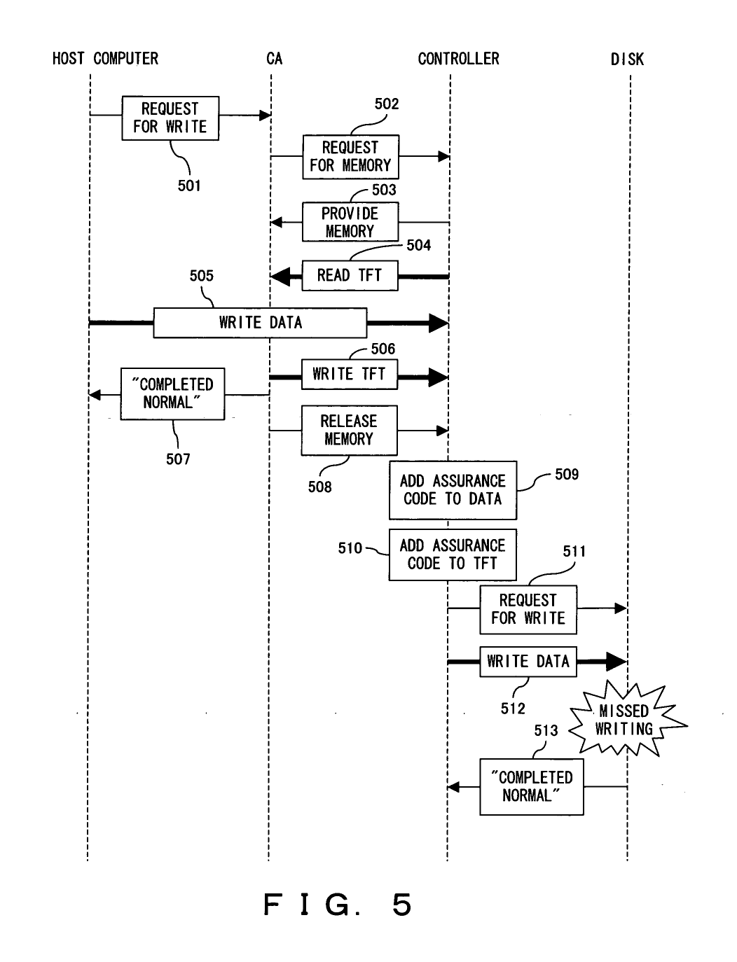

The next description is of sequences for write and read operations by using the format information shown by FIG. 4, while referring to FIGS. 5 through 10.

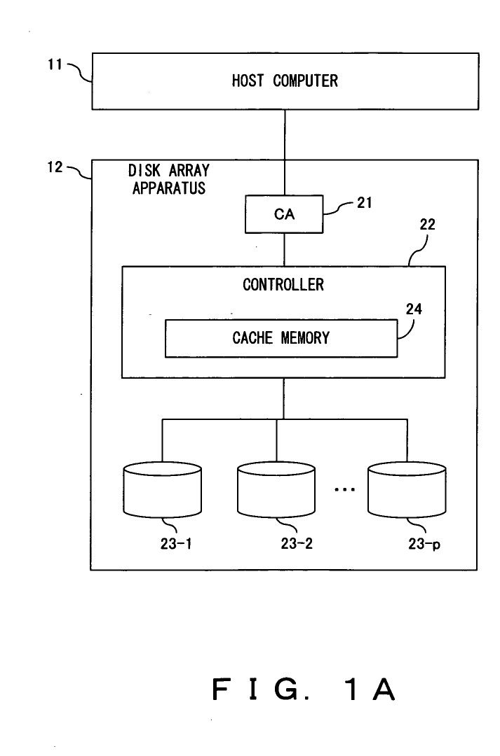

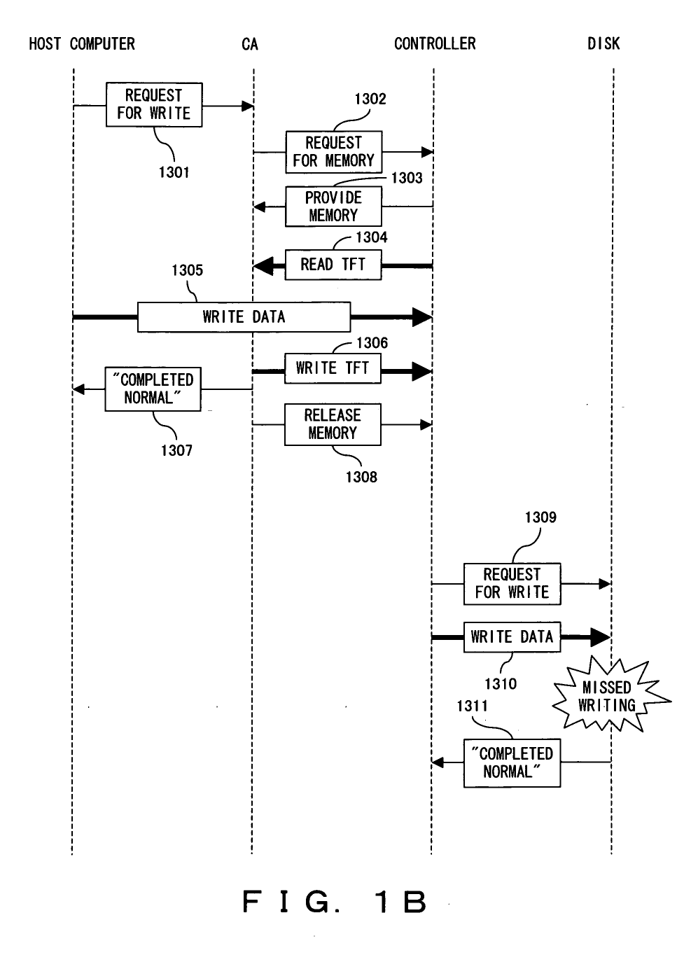

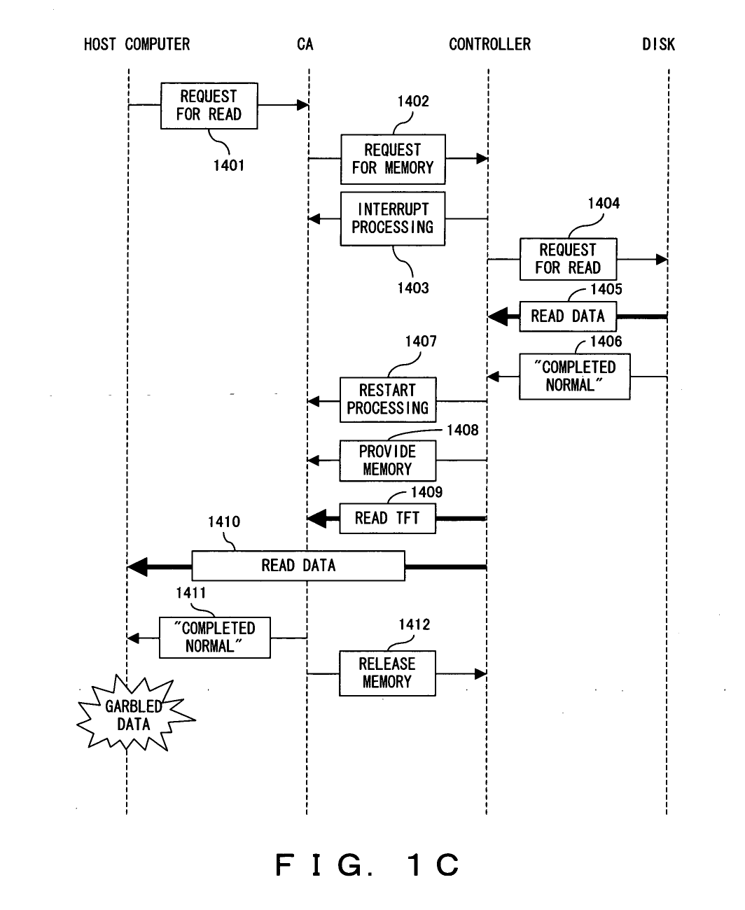

FIG. 5 shows a sequence of write operations by the disk array apparatus 202 having received a write request from the host computer 201. The operations in the steps 501 through 508 shown by FIG. 5 are the same as those in the steps 1301 through 1308 shown by FIG. 1B. The format information which is read out of the TFT in the step 504 contains the assurance code 406 which has been added at the time of the last writing.

As the channel adaptor 211-1 releases the memory area provided by the controller 212-1, the controller 212-1 generates a new time stamp based on the current date and time, and reads the number of updates 412 contained by the format information of the writing track from the TFT stored in the cache memory 224-1 to regenerate the number of updates by incrementing the aforementioned number of updates 412. This generates a new assurance code for the writing track.

This is followed by adding the new assurance code 301 to the write data retained by the cache memory 224-1 (step 509) and writing the new assurance code 301 to the assurance code of the format information of the writing track in the TFT as well (step 510).

Then the controller 212-1 transmits a request for a write to the disk 213 (step 511), and writes the write data retained by the cache memory 224-1 to the disk 213 (step 512), however the disk 213 will transmit a response back to the controller 212-1 of “completed normally” even if a missed write occurs (step 513).

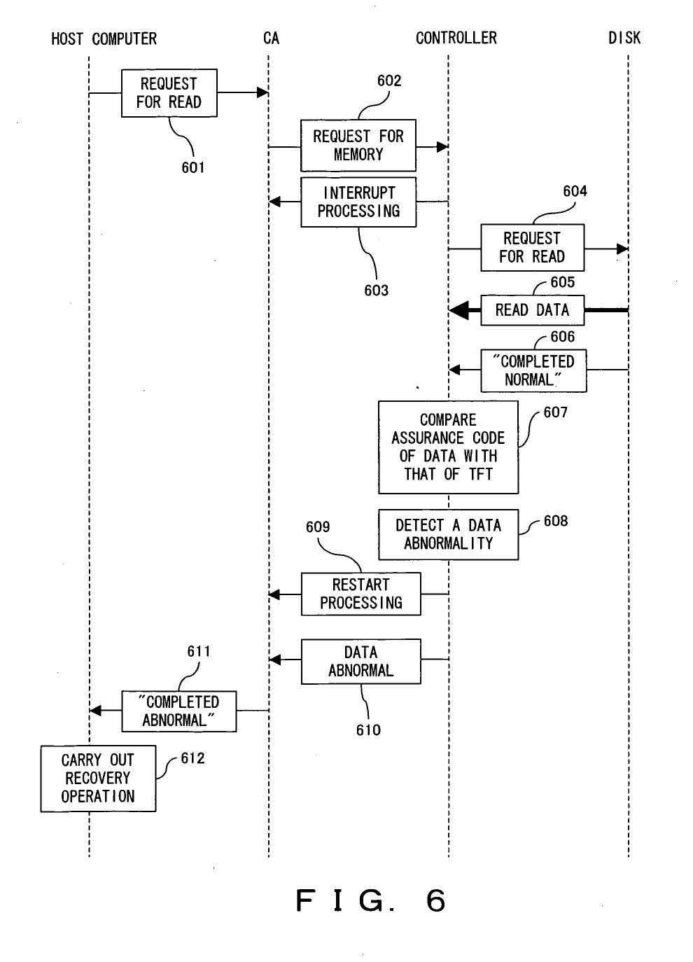

FIG. 6 shows a sequence of a read operation of the disk array apparatus 202 which has received a read request from the host computer 201 following the write operation shown by FIG. 5. The operations in the steps 601 through 606 are the same as those in the steps 1401 through 1406 shown by FIG. 1C. The data read from the disk 213 in the step 1405 contains the assurance code 301 added at the time of writing it.

Having received the response “completed normally” from the disk 213, the controller 212-1 compares the assurance code 301 of the data readout with the assurance code 406 of the format information of the reading track which is retained by the TFT in the cache memory 224-1 (step 607). If both the aforementioned codes identify with each other, the data readout is judged to be normal, while if they do not, then the data readout is judged to be abnormal.

As shown in FIG. 5, if a missed write occurred at the time of writing, then the data readout is recorded with an old assurance code 301 which does not identify with the assurance code 406 retained in the TFT, and therefore the data readout is judged to be abnormal (step 608).

Accordingly the controller 212-1 transmits a response “restarting processing” to the channel adaptor 211-1 (step 609) followed by transmitting the response “data abnormal” thereto (step 610). The channel adaptor 211-1 transmits the response “completed abnormally” to the host computer 201 (step 611). By this method, the host computer 201 recognizes the abnormality of the data readout to carry out a recovery operation (step 612).

In the above described operations, the controller 212-1 carries out the control for assuring data integrity, the channel adaptor 211-1 can also carry out the same control, however. In such a case, the MPU 221-1 comprised by the channel adaptor 211-1 executes the necessary processing by utilizing the cache memory 224-1 comprised by the controller 212-1.

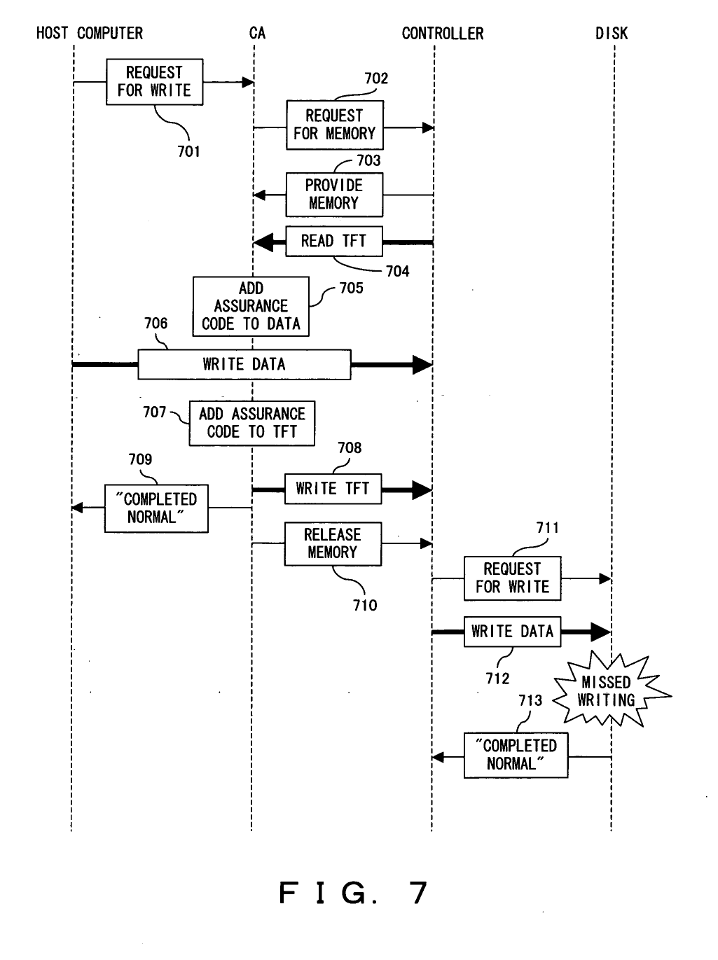

FIG. 7 shows a sequence of write operation in the case of the channel adaptor 211-1 assuring the integrity of data. The operations of the steps 701 through 704 shown by FIG. 7 are the same as those of the steps 501 through 504 shown by FIG. 5.

Having read the format information of the writing track from the TFT, the channel adaptor 211-1 generates a new assurance code as in the case of FIG. 5 (step 705), followed by writing the data and assurance code transmitted from the host computer 201 to a memory area of the cache memory 224-1 conforming to the format information (step 706). This adds the new assurance code 301 to the written data. The channel adaptor 211-1 adds the new assurance code 406 also to the format information of the writing track (step 707) and writes the format information in the TFT (step 708).

The operations of the subsequent steps 709 through 713 are the same as those of the steps 507, 508 and 511 through 513 shown by FIG. 5.

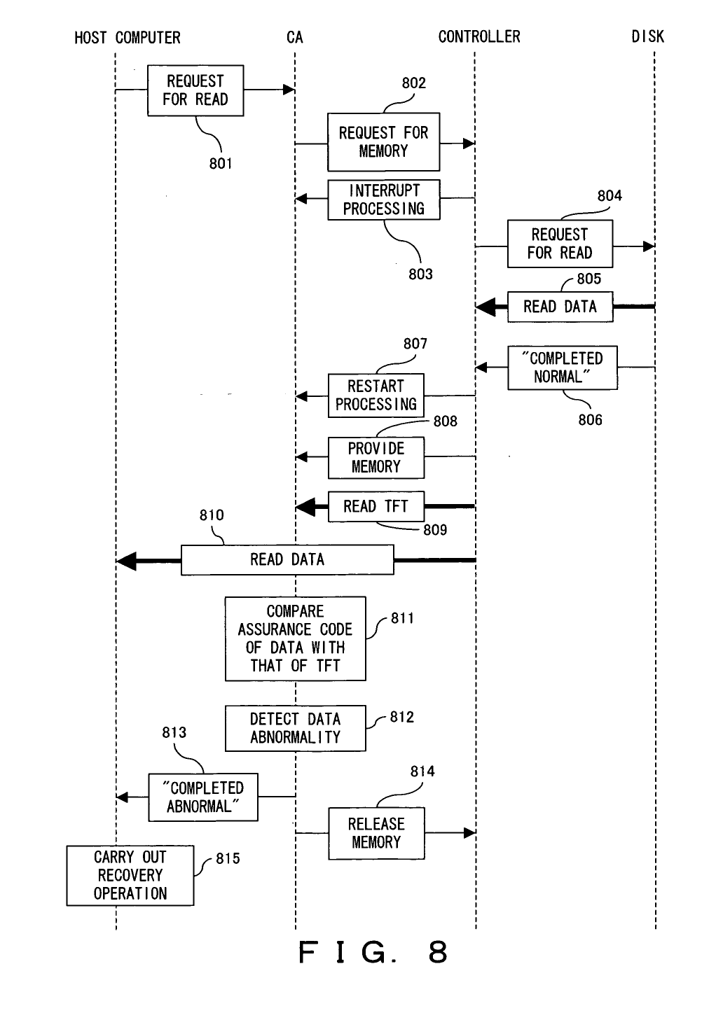

FIG. 8 shows a sequence of a read operation in the case of the channel adaptor 211-1 assuring the integrity of data. The operations of the steps 801 through 810 shown by FIG. 8 are the same as those of the steps 1401 through 1410 shown by FIG. 1C.

Having finished transmission of data to the host computer 201, the channel adaptor 211-1 compares the assurance code 301 of the data with the assurance code 406 of the format information about the read track (step 811). If a missed write occurred at the time of writing, the aforementioned codes will not identify with each other, hence the data is judged to be abnormal (step 812).

Accordingly the channel adaptor 211-1 transmits a response “completed abnormally” to the host computer 201 (step 813), and releases the memory area provided by the controller 212-1 (step 814). The host computer 201 recognizes the abnormality of the data readout by the received response and carries out a recovery operation accordingly (step 815).

In the meantime, if the data mirroring is conducted between the two magnetic disk apparatuses equipped in the disk 213, an occurrence of a missed write to one magnetic disk apparatus is conceivable, should it occur it would not affect the other magnetic disk apparatus. In such a case, it is possible to assure the normality of data by reading the data from the other magnetic disk apparatus in which a missed write did not occur.

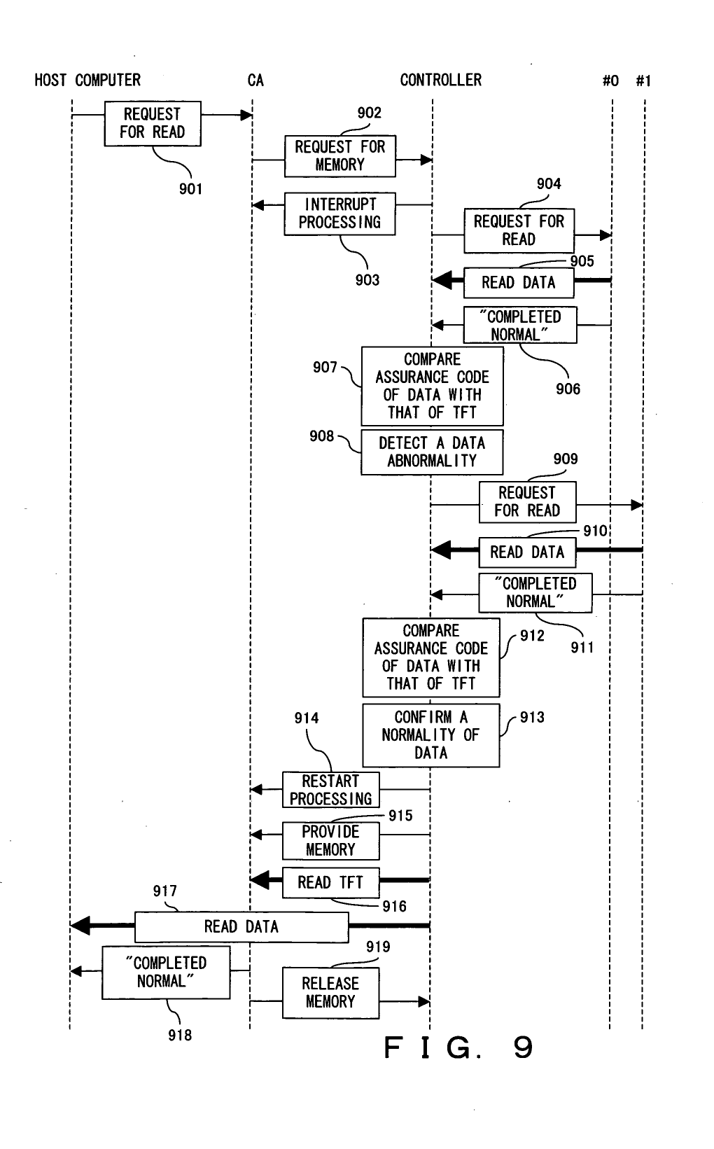

FIG. 9 shows a sequence of a read operation in the case of mirroring between the magnetic disk apparatuses #0 and #1 equipped in the disk 213. The operation of the steps 901 through 908 shown by FIG. 9 are the same as those of the steps 601 through 608 shown by FIG. 6. Note that the magnetic disk apparatuses #0 will be accessed as an object of reading (i.e., “a reading disk” hereinafter).

Having detected a data abnormality, the controller 212-1 carries out the same operations as the steps 904 through 906 by accessing the magnetic disk apparatus #1 (steps 909 through 911), and compares the assurance code 301 of the data readout of the magnetic disk apparatus #1 with the assurance code 406 of the format information of the reading track which is retained by the TFT in the cache memory 224-1 (step 912), by which the data readout is judged to be normal if both the aforementioned pieces of information identify with each other (step 913).

The operations in the subsequent steps 914 through 919 are the same as those in the steps 1407 through 1412 shown by FIG. 1C. As a result of the above described processing, normal data read out of the magnetic disk apparatus #1 will be transmitted to the host computer 201.

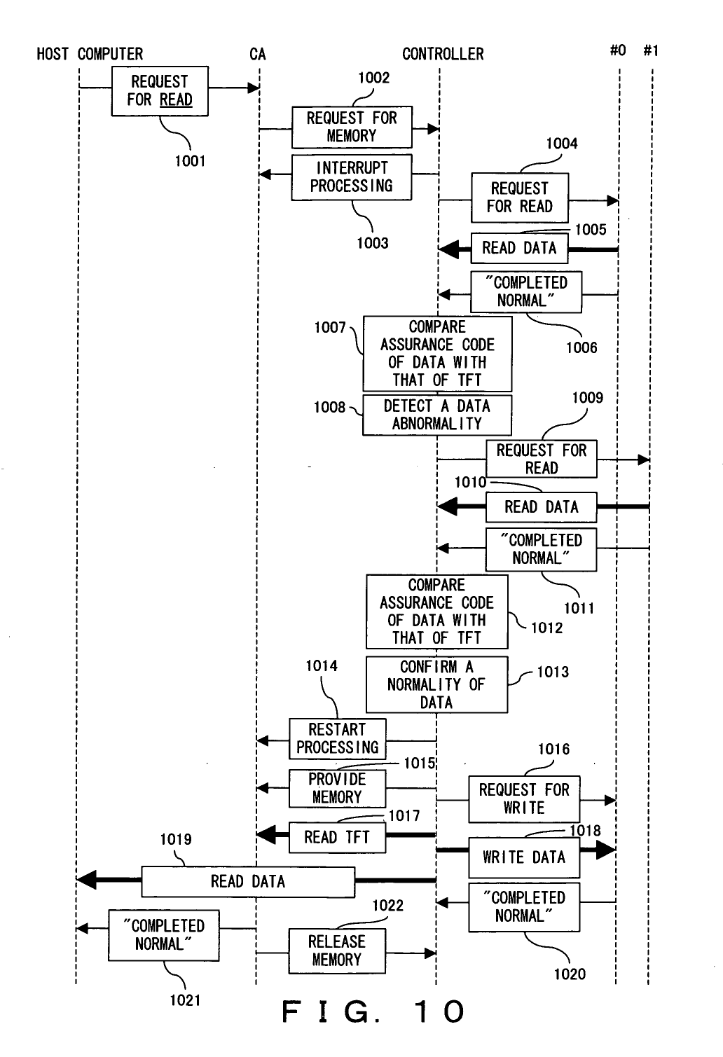

FIG. 10 shows a sequence of a read operation in the case of correcting data for the magnetic disk apparatus #0, in which a missed write occurred, by using the data recorded in the magnetic disk apparatus #1 in which a missed write did not occur. The operations of the steps 1001 through 1015 shown by FIG. 10 are the same as those of the steps 901 through 915 shown by FIG. 9.

The controller 212-1 provides a memory area to the channel adaptor 211-1, followed by transmitting a request for a read to the magnetic disk apparatus #0 (step 1016), while the channel adaptor 211-1 reads the format information of the read track from the TFT retained by the cache memory 224-1 (step 1017).

Then, the controller 212-1 writes a data readout of the magnetic disk apparatus #1 to the cache memory 224-1 in the magnetic disk apparatus #0 conforming to the format information (step 1018), while the channel adaptor 211-1 reads the same data from the cache memory 224-1 according to the format information and transmits the data to the host computer 201 (step 1019).

Subsequently the magnetic disk apparatus #0 transmits a response “completed normally” back to the controller 212-1 (step 1020). And the channel adaptor 211-1 transmits a response “completed normally” back to the host computer 201 (step 1021) and releases the memory area provided by the controller 212-1 (step 1022).

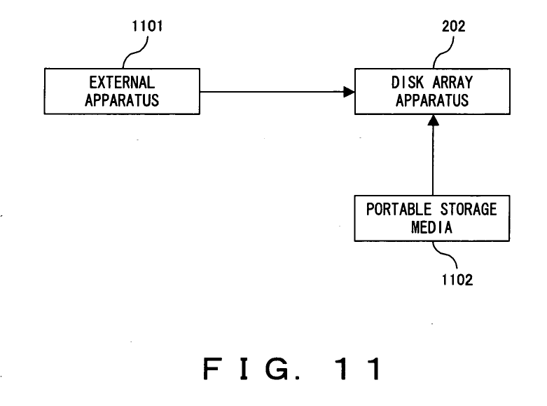

FIG. 11 shows a method for providing a program and data used for processing which is carried out by the MPUs 221-i and 222-i comprised by the disk array apparatus 202. The program and data stored by an external apparatus 1101, such as an information processing apparatus, or a portable storage apparatus 1102 will be loaded into the memories 223-i comprised by the disk array apparatus 202.

The external apparatus 1101 generates a carrier signal for carrying the program and data to transmit to the disk array apparatus 202 by way of an arbitrary transmission medium on a communications network. A portable storage medium 1102 is a discretionary computer readable storage medium such as a memory card, flexible disk, optical disk, magneto optical disk, et cetera. The MPUs 221-i and 222-i execute the program by using the data to carry out the necessary processes.

Incidentally, the above described embodiment employs a time stamp and the number of updates for an assurance code, however, either one of the two may be used for the assurance code. It is also possible to use an assurance code generated from the write data such as CRC (cyclic redundancy check), CHK SUM (check sum), ECC (error correcting code) and parity.

Moreover, the above described embodiment uses a magnetic disk apparatus for a storage apparatus; however, the present invention can be applied to other disk apparatuses, such as optical disk apparatus, magneto optical disk apparatus, or other storage systems using other storage apparatuses such as tape apparatus.

What is claimed is:

1. A file control apparatus for controlling writing a file made up of a plurality of records in a storage apparatus and reading from thereof in response to an access request from a requester, comprising:
a storage device for storing a track format table recording format information about each track of the storage apparatus;
a cache device for storing a data for writing to the storage apparatus and a data read out thereof; and
a control device for writing to the storage apparatus a write data transmitted from the requester by adding identifier information thereto in order to confirm a normality of the write data,
adding the identifier information to format information, of a writing track, which is recorded in the track format table when receiving a request for a write from the requester, and
notifying the requester of a data abnormality if identifier information of a data readout of the storage apparatus is not identical with the identifier information of the format information, of the reading track, which is recorded in the track format table when receiving a request for a read from the requester.

2. The file control apparatus according to claim 1, wherein said storage device stores a track format table common to two storage apparatuses, i.e., said storage apparatus and a storage apparatus for mirroring therewith; said cache device stores a write data for the two storage apparatuses and a data readout thereof; and said control device writes in the two storage apparatuses a write data transmitted from a requester by adding identifier information thereto in order to confirm a normality of the write data, adds the identifier information to format information, of a writing track, which is recorded in the track format table when receiving a request for a write from the requester; and reads a data from a first storage apparatus from between the two thereof and, if identifier information of the data readout does not identify with that of format information, of the reading track, which is recorded in the track format table, then reads a data from the second storage apparatus from between the two thereof and, if identifier information of the data readout identifies with that of format information of the reading track, transmits the data readout to the requester when receiving a request for a read from the requester.

3. The file control apparatus according to claim 2, wherein said control device corrects a data stored in said first storage apparatus by using a data readout of said second storage apparatus.

4. A file storage apparatus, comprising:
a plurality of storage apparatuses, each of which stores a file made-up of a plurality of records;
a storage device for storing a track format table recording format information about each track of a storage apparatus;
a cache device for storing a data for writing to storage apparatus and a data read from thereof; and
a control device for writing to one of the plurality of storage apparatuses a write data transmitted from a requester by adding identifier information thereto in order to confirm normality of the write data, adding the identifier information to format information, about a writing track, which is recorded in the track format table when receiving a request for a write from a requester, and notifying the requester of a data abnormality if identifier information of a data readout of the storage apparatus is not identical with the identifier information of the format information, about the reading track, which is recorded in the track format table when receiving a request for a read from the requester.

5. The file storage apparatus according to claim 4, wherein said storage device stores a track format table common to two storage apparatuses, i.e., one of said plurality of storage apparatuses and a storage apparatus for mirroring therewith; said cache device stores a write data for the two storage apparatuses and a data readout thereof; and said control device writes in the two storage apparatuses a write data transmitted from a requester by adding identifier information thereto in order to confirm a normality of the write data, adds the identifier information to format information, of a writing track, which is recorded in the track format table when receiving a request for a write from said requester, and reads a data out of a first storage apparatus from between the two thereof and, if identifier information of the data readout does not identify with that of format information, of the reading track, which is recorded in the track format table, then reads a data out of the second storage apparatus from between the two thereof and, if identifier information of the data readout identifies with that of format information about the reading track, transmits the data readout to the requester when receiving a request for a read from the requester.

6. A computer readable storage medium storing a program for a processor controlling writing a file made up of a plurality of records in a storage apparatus and reading it out thereof in response to an access request from a requester, wherein
the program makes the processor execute the processes of
writing to the storage apparatus a write data transmitted from the requester by adding identifier information thereto in order to confirm a normality of the write data,
adding the identifier information to format information, about a writing track, which is recorded in a track format table when receiving a request for a write from the requester, and
notifying the requester of a data abnormality if identifier information of a data readout of the storage apparatus is not identical with the identifier information of the format information, of the reading track, which is recorded in the track format table when receiving a request for a read from the requester.

7. The storage medium according to claim 6, wherein said program makes said processor execute the processes of
writing to two storage apparatuses, i.e., said storage apparatus and a storage apparatus for mirroring therewith, write data transmitted from a requester by adding identifier information thereto in order to confirm a normality of the write data, and adding the identifier information to format information, of a writing track, which is recorded in a track format table common to the two storage apparatuses when receiving a request for a write from said requester; and
reading data from a first storage apparatus of the two thereof and, if identifier information of the data readout does not identify with that of format information, of the reading track, which is recorded in the track format table, then reads data from the second storage apparatus of the two thereof and, if identifier information of the data readout identifies with that of format information of the reading track, transmits the data readout to the requester when receiving a request for a read from the requester.
